(19) United States
(12) Patent Application Publication
(10) Pub. No.: US 2012/0090145 A1
(43) Pub. Date: Apr. 19, 2012

(54) ELONGATE MEMBER ATTACHMENT APPARATUS AND METHOD OF USE THEREOF

(75) Inventor: Noah Montena, Syracuse, NY (US)

(73) Assignee: JOHN MEZZALINGUA ASSOCIATES INC., East Syracuse, NY (US)

(21) Appl. No.: 12/905,242

(22) Filed: Oct. 15, 2010

(51) Int. Cl. B23P 11/00; F16G 11/00; F16G 11/09

(52) U.S. Cl. 29/428; 24/132 R; 24/132 WL

(57) ABSTRACT

Disclosed herein is an elongate member attachment apparatus. The apparatus includes a main body capable of being pulled through at least one space. The main body has a bore-shaped opening that is receptive of an end of an elongate member. The apparatus further includes a fastening mechanism configured to secure the elongate member within the bore-shaped opening of the main body.

### FIELD OF TECHNOLOGY

The subject matter disclosed herein relates generally to the field of pulling elongated members such as, for example, wires and cables. More particularly, the subject matter described herein relates to an apparatus that is attachable over a cable and facilitates the pulling of the cable through a path such as a conduit or the interior of a monopole.

### BACKGROUND

There are many situations where it is desirable to pull an end of an elongated member, such as a wire or cable, through a length of a conduit or other such confined space. In the telecommunication industry, for example, copper wire, fiber optic cable, telecommunication wire, or feeder cable must often be fed through metal or plastic conduits, monopoles of a cell tower, or the like. It is often the case that these conduits or confined spaces include obstructions that may cause the cables or wires to catch, drag or snag. Additionally, many cables or wires include connectors that are located at the end to be pulled. These connectors have the potential to become damaged during the pulling process.

One particular instance where an elongated member must be pulled through a confined space is during the installation of feeder cables at the top of cell towers. These feeder cables carry signals to and from the base station to tower-top antennas. Feeder cables typically include a heavy and bulky insulation, making them more difficult to pull to the top of the cell tower. Additionally, the feeder cables must often be pulled through tight spaces that have previously installed lines or cables. In order to pull the feeder cables to the top of a cell tower for installation, it is known in the art to install a mesh pulling harness at the leading end of each feeder cable that is to be pulled. These mesh harnesses require significant care and physical effort to install and may be damaging to an installer's hands. The mesh harnesses are also likely to catch, drag or otherwise get stuck at some point while the feeder cables are being pulled to the top. Furthermore, if the mesh harness does not sufficiently cover the connector located at the leading end, the bulges and edges of the connectors may also cause the feeder cable to catch or snag. Sometimes multiple attempts to pull the feeder cables to the top of the cell tower may be required.

Accordingly, an elongate member attachment apparatus for the pulling of an elongate member through a path, and method of use thereof, would be well received in the art.

### SUMMARY

A first general aspect is described as an elongate member attachment apparatus comprising a main body capable of being pulled through at least one space, the main body having a bore-shaped opening that is receptive of an end of an elongate member; and a fastening mechanism configured to secure the elongate member within the bore-shaped opening of the main body.

A second general aspect is described as a feeder cable attachment apparatus comprising a main body capable of being pulled up a cell tower, the main body having a cradle that is receptive of an end of a feeder cable; a hinged flap that is operable to allow access to the cradle; and a releasable fastening mechanism configured to secure the hinged flap in a closed position.

A third general aspect is described as a method of installing a feeder cable on a cell tower comprising introducing an feeder cable to an opening in a main body of a feeder cable attachment apparatus; fastening the feeder cable securely within the opening of the main body of the feeder cable attachment apparatus; and pulling the feeder cable attachment apparatus and the fastened feeder cable up a cell tower.

### BRIEF DESCRIPTION OF THE DRAWINGS

Some of the embodiments will be described in detail, with reference to the following figures, wherein like designations denote like members, wherein:

FIG. 1 depicts an embodiment of an elongate member attachment apparatus in an embodiment of a fastened position;

FIG. 2 depicts the elongate member attachment apparatus of FIG. 1 in an embodiment of an unfastened position; and

FIG. 3 depicts the cable attachment apparatus of FIGS. 1 and 2 in an embodiment of an unfastened position and having received an embodiment of an elongate member.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

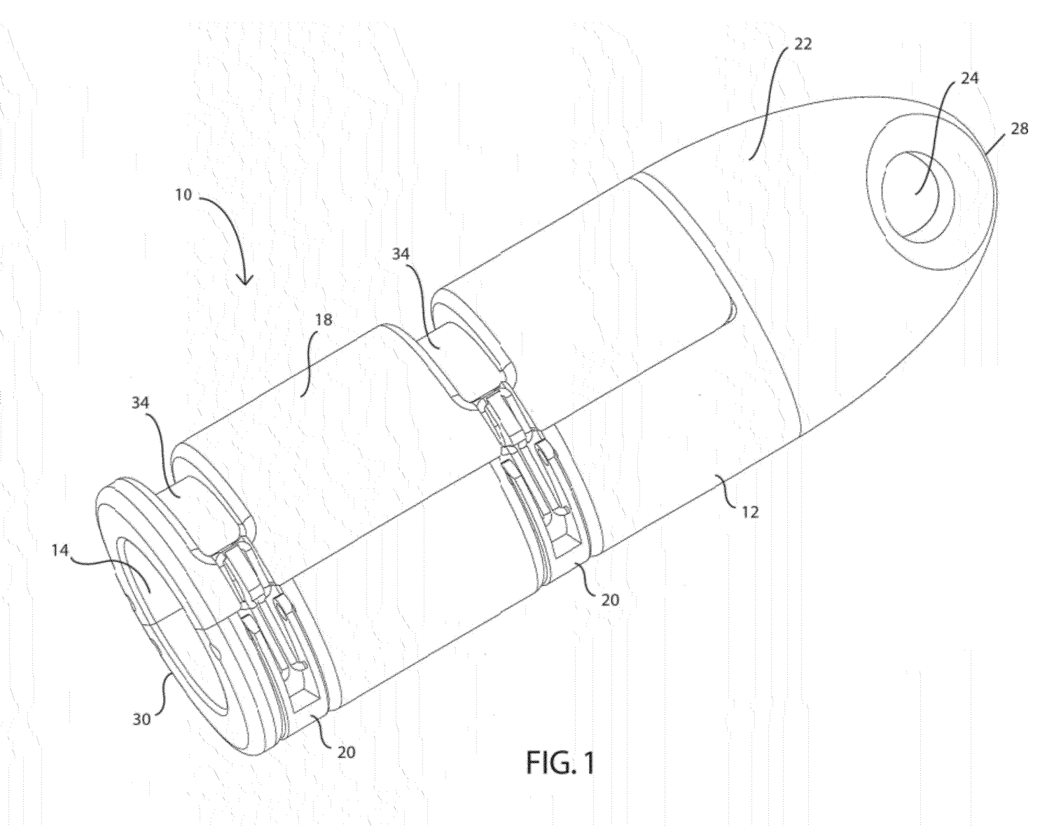

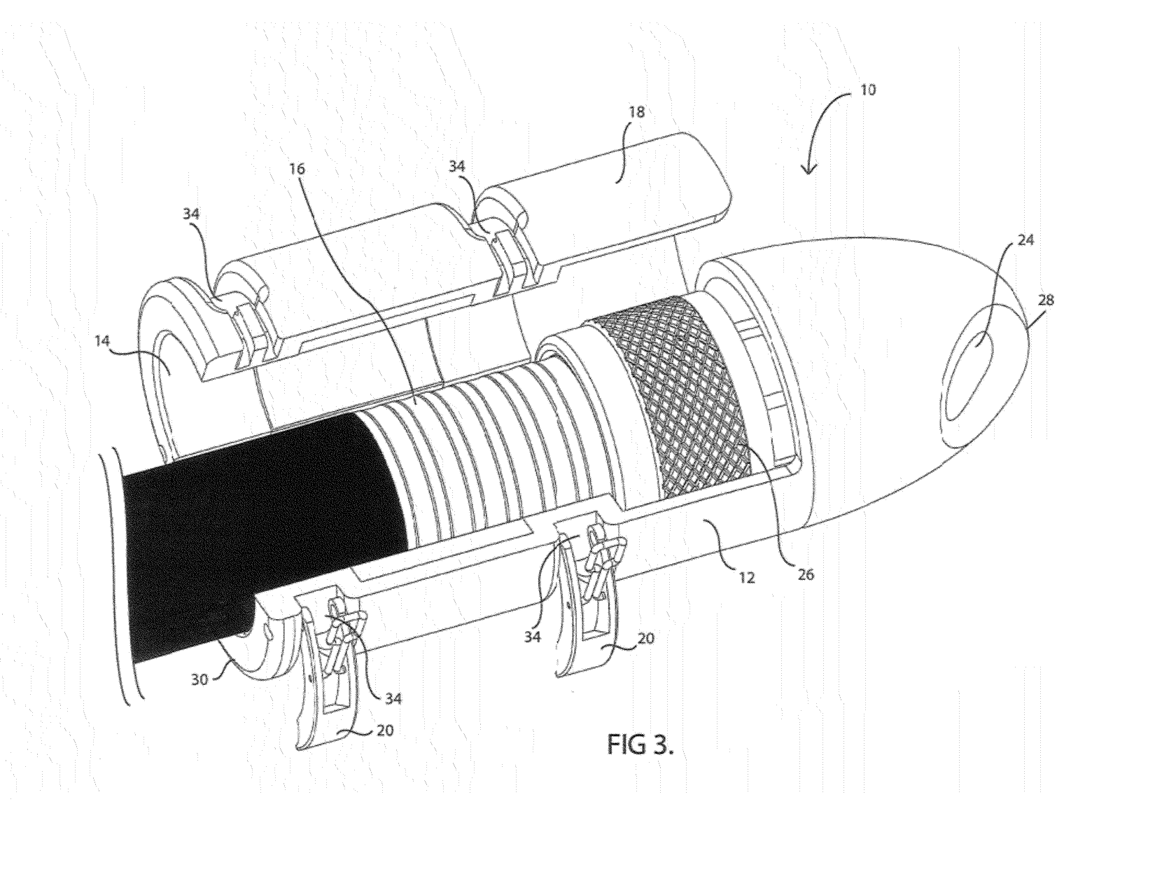

Referring to FIG. 1, an embodiment of an elongate member attachment apparatus 10 is shown. The elongate member attachment apparatus 10 includes a main body 12 having a bore-shaped opening 14. The bore-shaped opening 14 is receptive of an elongate member 16 (shown in FIG. 3) such as a cable or wire. The elongate member attachment apparatus 10 further includes a hinged flap 18 that is operable to allow the elongate member 16 access to the opening 14. The elongate member attachment apparatus 10 further includes at least one fastening mechanism 20. In addition, the elongate member attachment apparatus may include a plurality of fastening mechanisms 20. The fastening mechanisms 20 may be configured to secure hinged flap 18 in a closed position and to thereby secure the elongate member 16 within the bore-shaped opening 14. As such, the fastening mechanism(s) 20 may comprise means for securing the elongate member 16 within the bore-shaped opening 14 of the main body 12. Furthermore, the main body 12 of the elongate member attachment apparatus 10 includes a tapered surface 22 having an opening 24 that is configured for insertion of a pulling cord (not shown). Thus, the elongate member attachment apparatus 10 and a secured elongate member 16 are capable of being pulled by the pulling cord through at space such as a conduit or a monopole of a cell tower, by utilization of a pulling cord inserted through the opening 24, which may serve as means for pulling the elongate member attachment apparatus 10, once the elongate member 16 is secured within the apparatus 10. The main body 12 of the elongate member attachment apparatus 10 is configured to protect the elongate member 16 and the tapered surface 22 is configured to prevent snags during the pulling process.

It should be understood that embodiments of the elongate member attachment apparatus 10 may be configured for the attachment of any type of wire, cable, line, cord, string or other elongate member that needs to be pulled along a space. For example, the elongate member attachment apparatus 10 may be configured for use with feeder cables for a cell tower, CATV cable or fiber optic cables installed in building conduits, or the like. Non-electronic line uses are also contemplated. It should be understood that the elongate member attachment apparatus 10 may be specifically dimensioned to fit any of these elongate members. For example, the elongate member attachment apparatus 10 may have much larger dimensions when intended for use with cell tower feeder cables than if it was dimensioned for use with coaxial cable.

The main body 12 of the elongate member attachment apparatus 10 is shown having a generally bullet-shaped profile. The tapered surface 22 of the of the elongate member attachment apparatus 10 may assist in streamlining and snag prevention during pulling. Any appropriate taper is contemplated. For example, the tapered surface 22 may have a greater curvature and a shorter length, or a lesser curvature and greater length. However, it should be understood that the main body 12 may be any shape that would facilitate the protection of the elongate member 16 and/or the prevention of snagging during a pulling process. For example, the main body 12 may simply be a cylindrical shape without the tapered surface 22 for use in applications where snagging is not an issue. In this case, the elongate member attachment apparatus 10 may still be useful in providing an attachment means for the pulling cord and preventing direct pressure on a connector 26 (shown in FIG. 3) of the elongate member 16. Further, a substantially square or rectangular cross section of the main body 12 may also be appropriate in the case of an elongate member that likewise has a substantially square or rectangular cross section.

Whatever the profile, the main body 12 of the elongate member attachment apparatus 10 is capable of being pulled through at least one space. In the embodiment depicted in the Figures, this pulling capability is provided substantially by the opening 24 that is configured for insertion of the pulling cord. The opening 24 may be molded, bored or otherwise fabricated into a leading end 28 of the main body 12. Alternately, an opening may be provided by an external component of the elongate member attachment apparatus 10 that is not integral to the main body 12. Whatever the embodiment, it is contemplated that the opening has a sufficient diameter to allow for the pulling cord, string, wire, or rope to be inserted therein. After insertion, the pulling chord may be drawn from a single end through the opening while the other end remains stationary (as in a pulley system) in order to propel the elongate member attachment apparatus through the space or conduit. Alternately, the pulling cord may be tied to the opening. Furthermore, it is contemplated that the pulling capability of the elongate member attachment apparatus 10 may be provided by a means other than an opening. For example, the main body 12 may include a hook, snap, or other fastener that attaches, mates or otherwise joins with the pulling cord, string, wire, or rope.

Referring still to FIG. 1, the bore-shaped opening 14 is shown extending axially from a trailing end 30 within the main body 12. It should be understood that the term “bore” is used merely to describe the configuration of the opening 14 within the main body 12 and does not imply any particular methods by which the bore-shaped opening 14 may be fabricated. Thus, the bore-shaped opening 14 may or may not be fabricated in the main body by a drilling process, but may instead be created with a molding process, a milling process, any other fabrication method that would be apparent to those skilled in the art. It should also be understood that the opening 14 may or may not have a circular cross-section but may be any other shape that would accommodate the dimensions of an elongate member to be pulled. For example, the opening 14 may have a square or rectangular cross section in the case of an elongate member that likewise has a substantially square or rectangular cross section. Whatever the shape, it should be understood that the opening 14 should be dimensioned such that the elongate member 16 is securable within when the fastening mechanisms 20 are fastened.

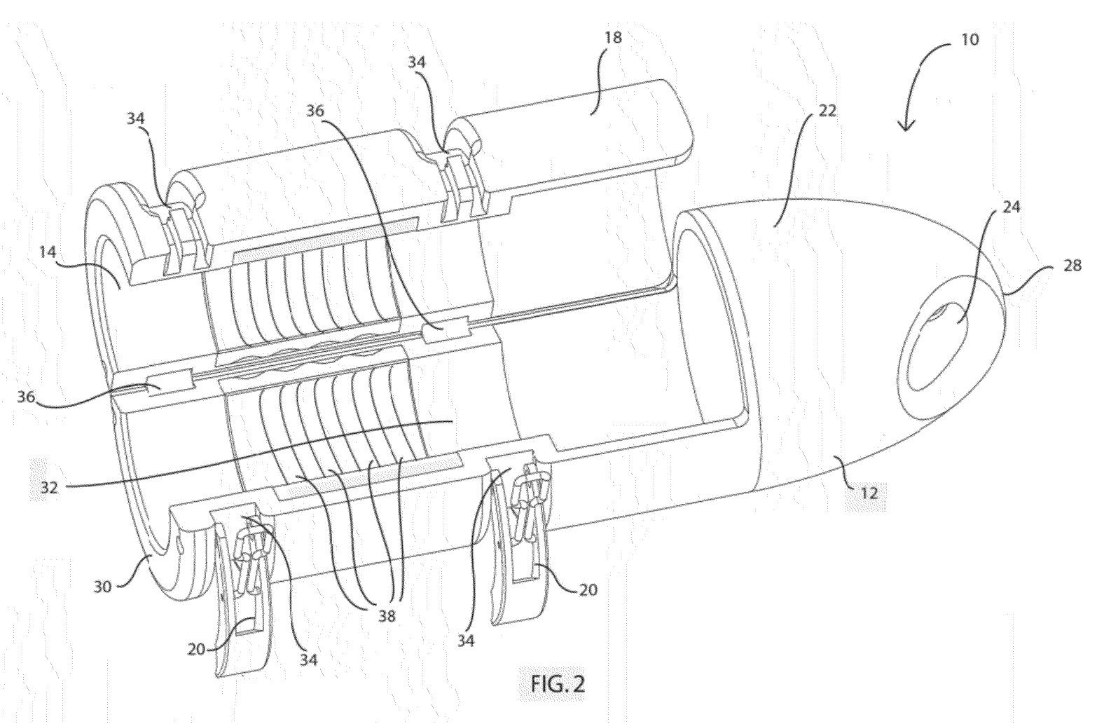

While FIG. 1 shows the hinged flap 18 and fastening mechanisms 20 in the fastened and closed position, FIG. 2 shows the hinged flap 18 and fastening mechanism 20 in the unfastened and open position, revealing a cradle 32 of the main body 12. The elongate member attachment apparatus 10 is shown having two fastening mechanisms 20 that may be used for latching component elements together. However, any number of fastening mechanisms is contemplated. These fastening mechanisms 20 may be releasable so that the elongate member attachment apparatus 10 may be removed after the elongate member 16 is pulled. In the embodiment depicted in the Figures each of the two fastening mechanisms 20 are draw latches. However, other fastening members are contemplated such as a cam lock latch, a slam latch, a spring latch, a bolt lock latch, a compression latch, a rotary latch and/or other latch-type mechanism or the like. Hereinafter, a fastening mechanism means a mechanical fastener that typically joins two surfaces together while allowing for the regular or eventual separation of those two surfaces. Furthermore, other fastening means are contemplated beyond latching mechanisms, such as one or more clamps, bolts, buckles, screws, nails, snaps and the like.

In order to accommodate the fastening mechanisms 20, the main body 12 of the elongate member attachment apparatus 10 may include recesses 34. When in the locked closed pulling position, the fastening mechanisms 20 may rest within the recesses in order to further prevent snagging and also prevent an object from unlatching the fastening members 20 during a pulling operation.

Referring still to FIG. 2, the hinged flap 18 of the elongate member attachment mechanism 10 includes two hinges 36 and encompasses a half-circular cross section extending from the trailing end 30 to the main body 12, operably allowing the elongate member 16 to access to the cradle 32. The elongate member attachment mechanism 10 is not limited to this embodiment, however. For example, the flap 18 may not include hinges, but may include fastening mechanisms 20 on both annular ends such that the flap 18 is completely removable from the main body 12. Alternately, the material of the main body 12 may be flexible or pliable such that the hinges 36 are unnecessary. Moreover, the hinged portion may comprise shapes other than a half-circular cross-section. In an unhinged embodiment, the main body 12 may be pulled open to provide access for the elongate member 16.

Referring still to FIG. 2, the cradle 32 of the main body 12 is shown having a plurality of axial concentric ridges 38 for gripping the elongate member 16. The axial concentric ridges 38 are positioned in the cradle 32 closer to the trailing end 30 such that they grip the outer insulation of the cable, rather than the connector 26 of the elongate member 16. This may help to prevent pressure or force from being applied to the connector 26, which might damage it during pulling of the elongate member 16. The concentric ridges may also be located on the hinged flap 18 in the same manner, as shown. It should be understood that the structural configuration is not limited to concentric ridges, but that any gripping mechanism is contemplated. For example, the cradle 32 and interior of the hinged flap 18 may include knurled protrusions, protrusions without having any patterns, or the like. In some embodiment, no ridges are required, and the cradle 32 and flap 18 may form an interference fit with the elongate member 16 in order to secure the elongate member 16 and prevent pressure on the connector 26.

Referring now to FIG. 3, the elongate member attachment apparatus 10 is shown in an open position and after having received the elongate member 16 in the cradle 32. The elongate member 16 is shown as a feeder cable of a cell tower. However, it should be understood that the elongate member attachment apparatus 10 of the present invention may be configured for the attachment of any type of wire, cable, line, cord, string or other elongate member that needs to be pulled along a space. For example, the elongate member attachment apparatus 10 may also be configured for use with CATV cable or fiber optic cables installed in building conduits, or the like. Non-electronic line or cable uses are also contemplated. It should be understood that the elongate member attachment apparatus 10 may be specifically dimensioned to fit any of these elongate members. For example, the elongate member attachment apparatus 10 may be much larger when dimensioned for use with cell tower feeder cables than if it was dimensioned for use with coaxial cable.

The connector 26 of the elongate member 16 is shown located at the leading end 28 of the elongate member attachment apparatus 10. The opening 14 may have a diameter that is large enough across the length of the connector 26 such that the connector 26 does not experience any pressure or force after the fastening mechanisms 20 have been fastened or closed.

It should be understood that the components of the elongate member attachment apparatus 10 may be fashioned from any desirable material that would be apparent to those skilled in the art. For example, the main body 12 may be fashioned from a plastic, metal, ceramic, or a combination thereof. Other materials that may be utilized in the present invention may include glass fibers, or other such composite. In the case that the elongate member attachment apparatus 10 is dimensioned for feeder cables, the components should be robust enough to support the weight of the entire feeder cable line in the pulling process. Additionally, in the case that the elongate member attachment apparatus 10 is reusable, the materials should have durable properties to support several pulling operations.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. An elongate member attachment apparatus comprising:
a main body capable of being pulled through at least one space, the main body having a bore-shaped opening that is receptive of an end of an elongate member; and
a fastening mechanism configured to secure the elongate member within the bore-shaped opening of the main body.

2. The apparatus of claim 1, wherein a leading end of the main body includes a tapered guide surface.

3. The apparatus of claim 1, wherein the main body is configured to hingably open prior to fastening the fastening mechanism.

4. The apparatus of claim 1, wherein a leading end of the main body includes an opening configured for insertion of a pulling cord.

5. The apparatus of claim 1, wherein the bore-shaped opening includes at least one gripping protrusion configured to grip the elongate member when the fastening mechanism is fastened.

6. The apparatus of claim 1, wherein the fastening mechanism is a latching-type mechanism that is releasable after latching to release the elongate member from the main body.

7. The apparatus of claim 1, wherein the elongate member is a feeder cable for a cell tower

8. The apparatus of claim 1, wherein the bore-shaped opening is configured to accept a connector of the feeder cable.

9. The apparatus of claim 1, wherein the fastening mechanism is a draw latch.

10. The apparatus of claim 1, wherein the at least one space is a monopole of a cell tower.

11. A feeder cable attachment apparatus comprising:
a main body capable of being pulled up a cell tower, the main body having a cradle that is receptive of an end of a feeder cable;
a hinged flap that is operable to allow access to the cradle; and
a releasable fastening mechanism configured to secure the hinged flap in a closed position.

12. The apparatus of claim 11, wherein a leading end of the main body includes a tapered guide surface.

13. The apparatus of claim 11, wherein a leading end of the main body includes an opening configured for insertion of a pulling cord.

14. The apparatus of claim 11, wherein the cradle includes at least one gripping protrusion configured to grip the elongate member when the fastening mechanism is fastened.

15. The apparatus of claim 11, wherein the fastening mechanism is a mechanism selected from the group consisting of a clamp, a latch, a bolt, a buckle, a screw, a nail, and a snap.

16. The apparatus of claim 11, wherein the fastening mechanism is a draw latch.

17. An elongate member attachment apparatus for pulling an elongate member once the elongate member is attached to the elongate member attachment apparatus, the elongate member attachment apparatus comprising:
a main body capable of being pulled through at least one space, the main body having a bore-shaped opening that is receptive of an end of an elongate member;
means for securing the elongate member within the bore-shaped opening of the main body; and
means for pulling the elongate member attachment apparatus, once the elongate member is secured within the apparatus.

18. A method of installing a feeder cable on a cell tower comprising:
introducing an feeder cable to an opening in a main body of a feeder cable attachment apparatus;
fastening the feeder cable securely within the opening of the main body of the feeder cable attachment apparatus; and
pulling the feeder cable attachment apparatus and the fastened feeder cable up a cell tower.

19. The method of claim 18, further comprising unfastening the feeder cable attachment apparatus from the feeder cable.

20. The method of claim 19, further comprising connecting the feeder cable to the cell tower.

21. The method of claim 19, further comprising reusing the feeder cable attachment apparatus on a second feeder cable.
